(19) United States
(12) Patent Application Publication
(10) Pub. No.: US 2005/0279857 A1
(43) Pub. Date: Dec. 22, 2005

(54) Sprinkler spacer

(76) Inventor: Buu Chi Quach, San Jose, CA (US)

Correspondence Address: Buu Chi Quach, 1436 Leaftree Circle, San Jose, CA, 95131, US

(21) Appl. No.: 11/156,978

(22) Filed: Jun. 20, 2005

Related U.S. Application Data
(60) Provisional application No. 60/581,893, filed on Jun. 22, 2004.
(60) Provisional application No. 60/629,848, filed on Nov. 19, 2004.

(51) Int. Cl. B05B 15/06; A01G 25/06; E01H 3/04

(52) U.S. Cl. 239/200; 239/202; 239/201

(57) ABSTRACT

In accordance with the present invention, there is provided a ring with four stakes located symmetrically on the bottom side of the ring, and a gasket made of stretchable material with four holes sized to fit over the stakes. The opening of the ring is bigger than the target sprinkler cap so the whole assembly can be push down over the sprinkler cap. On the other hand, the center opening of the gasket is sized smaller than the target sprinkler cap in order to have it tightly hugging the sprinkler's cap or its body to prevent grass from growing within the protected area. Since grass is not able to grow within the sprinkler spacer perimeter, it is no longer difficult to locate the sprinkler when needed. The sprinkler spacer does not interfere with lawn mowing operation.

### RELATED APPLICATIONS

This application claims the benefit of U.S. provisional patent application Ser. No. 60/581,893, filed Jun. 22, 2004 by the present inventor.

This application claims the benefit of U.S. provisional patent application Ser. No. 60/629,848, filed Nov. 19, 2004 by the present inventor.

### FIELD OF THE INVENTION

The present invention relates to sprinkler spacers and, more particularly, to a sprinkler spacer that is to keep the sprinkler's head from clogging due to grass or debris.

### BACKGROUND OF THE INVENTION

Ever since the in-ground sprinklers were invented, there has been a need to prevent them from clogging due to debris and nearby grass. There is also a desire to easily locate the locations of the sprinklers in case of service or routine inspection.

In some areas on the lawn, many lawn carers have to trim a broad area of grass around the sprinklers.

Trimming the grass around the sprinkler does not solve the problem effectively, since grass will grow back over time. Besides, trimming the grass too low will weaken the grass root, thus yielding a big yellow spot around the sprinklers making the lawn less appealing.

It is an object of the invention to provide clearance between the sprinkler and surrounding grass.

It is another object of the invention to prevent the sprinkler head from clogging due to grass or debris.

It is another object of the invention to easily locate the sprinkler.

It is another object of the invention to divert excess water away from the sprinkler to keep the soil around it stay intact.

It is another object of the invention to not interfere with lawn mowing operation.

### SUMMARY OF THE INVENTION

In accordance with the present invention, there is provided a ring with four stakes located symmetrically on the bottom side of the ring, and a gasket made of stretchable material with four holes sized to fit over the stakes. The opening of the ring is bigger than the target sprinkler cap so the whole assembly can be pushed down over the sprinkler cap. On the other hand, the center opening of the gasket is sized smaller than the target sprinkler cap in order to have it tightly hugging the sprinkler cap or its body to prevent grass from growing within the protected area. Since grass is not able to grow within the sprinkler spacer perimeter, it is no longer difficult to locate the sprinkler when needed. The sprinkler spacer does not interfere with lawn mowing operation.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top view of a sprinkler cover.;

FIG. 2 is a bottom view of a sprinkler cover.;

FIG. 3 is a top view of a gasket.;

FIG. 4 is a top view of an alternate embodiment of the gasket.;

FIG. 5 is a side view of a sprinkler spacer.;

FIG. 6 is a top view of a sprinkler spacer.;

FIG. 7 is a perspective top view of a sprinkler spacer.; and

FIG. 8 is a bottom view of an alternate embodiment of the sprinkler cover.

For purposes of clarity and brevity, like elements and components will bear the same designations and numbering throughout the FIGURES.

### DESCRIPTION OF THE PREFERRED EMBODIMENT

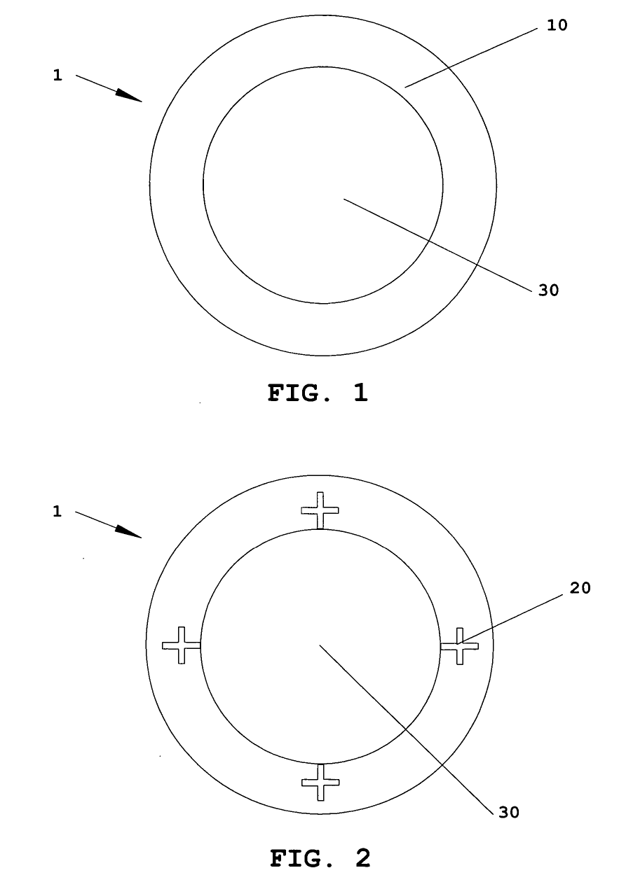

FIG. 1 is a top view of the sprinkler cover 1. There is the sprinkler cover surface 10 and the sprinkler cover opening 30. Sprinkler cover opening 30 is circular in the preferred embodiment, but it can be shaped as polygon or any other shape. The sprinkler cover 1 can be fabricated from plastic, rubber, metal, or any other suitable material, and may be shaped as polygon or any other geometrically shape deem to be aesthetically pleasing to the user. The sprinkler cover 1 can also be made with break-away tabs or material that can be easily trimmed to fit over sprinkler located near the border of the lawn. The sprinkler cover 1 can be colored in black, green, or any decorative color.

FIG. 2 is a bottom view of the sprinkler cover 1. The stakes 20 are crossed-shaped as viewed from the bottom, but they can be shaped in a way that helps to cut through the soil with ease and to keep the sprinkler spacer device imbedded firmly on the ground. Stakes 20 are located symmetrically on the bottom of sprinkler cover 1.

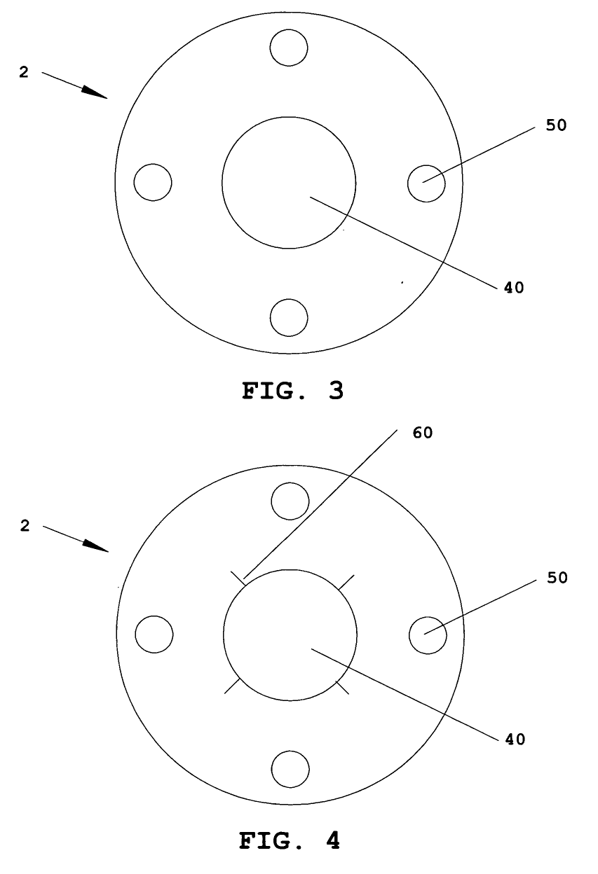

FIG. 3 is a top view of the gasket 2. The gasket center opening 40 is circular in shape. Gasket center opening 40 is sized much smaller than the target sprinkler cap so it can hug tightly around the sprinkler cap or its body when it is in place. There are four stake guided holes 50 located symmetrically on gasket 2. Stake guided holes 50 are to fit over stakes 20 of sprinkler cover 1 to complete the assembly of the inventive sprinkler spacer shown in FIG. 7. Gasket 2 can be fabricated with stretchable material such as rubber, neoprene, etc.

FIG. 4 is a top view of an alternate embodiment of the gasket 2. There are four small pre-cut lines 60 located symmetrically around the gasket center opening 40, and centered in between stake guided holes 50. These small pre-cut lines aids in the expansion of the gasket center opening 40.

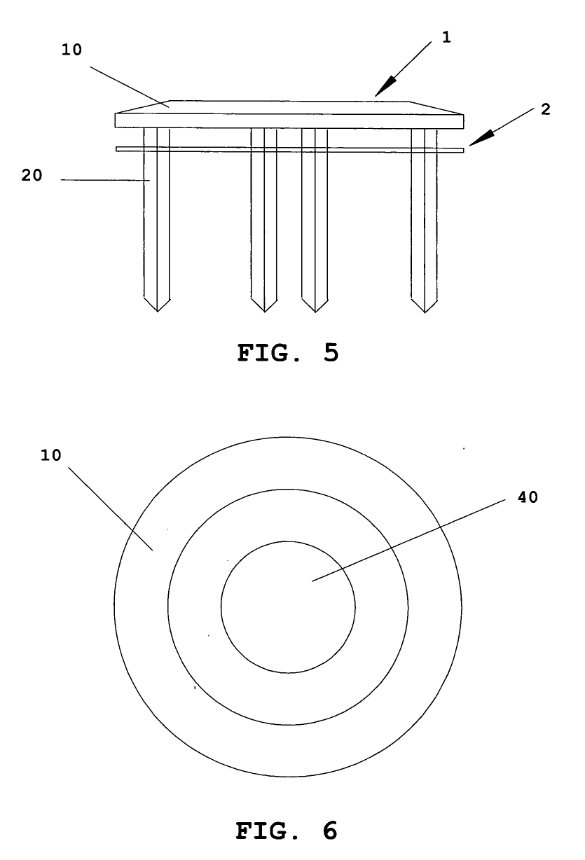

FIG. 5 is a side view of the inventive sprinkler spacer. The sprinkler cover surface 10 is slopped outward from the center so water can drain away from the sprinkler, and grass is not able to grow on the surface. The stakes 20 can be made separately and be attached mechanically when ready to use instead of molded together with the top portion of the sprinkler cover 1 for ease in packaging. Once installed, the sprinkler spacer should sit firmly on the ground with partial or whole body of stakes 20 imbedded in ground.

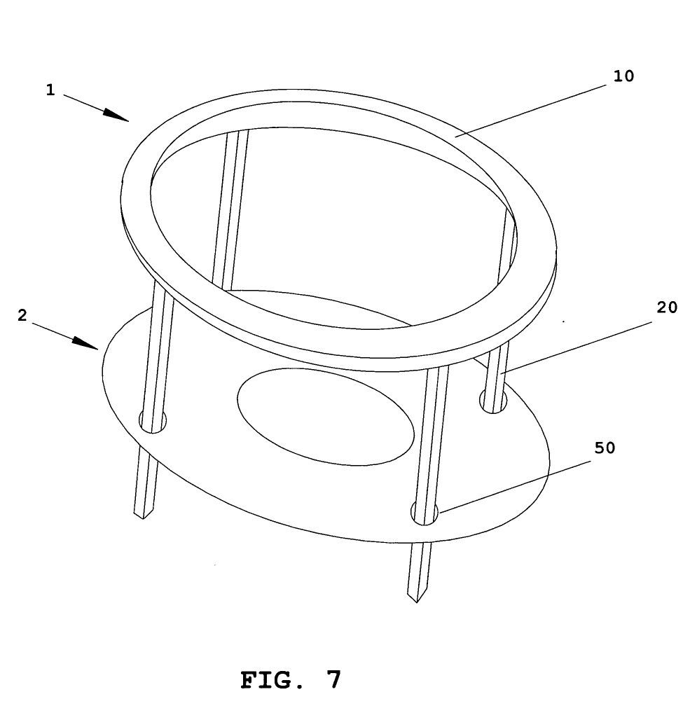

FIG. 6 is a top view of a sprinkler spacer. Once assembled, the only opening of the device is the gasket center opening 40 to allow the sprinkler spacer to go over the target sprinkler.

FIG. 7 is a perspective top view of a sprinkler spacer in accordance with the invention. It should be obvious that any shape for sprinkler cover 1 can be used, provided that the gasket 2 is made of stretchable material so that the whole assembly can fit over the target sprinkler with ease.

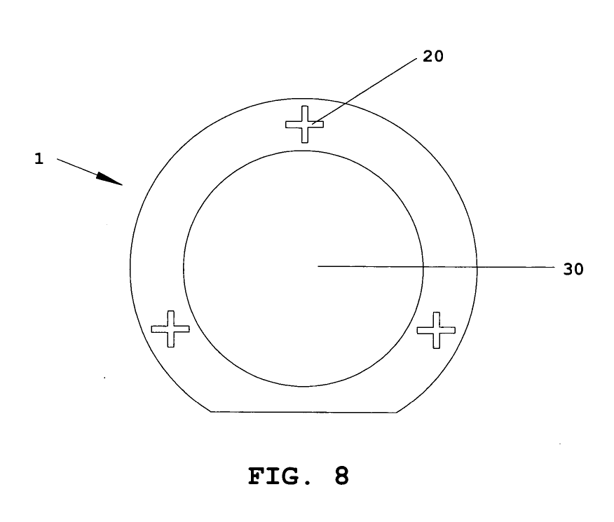

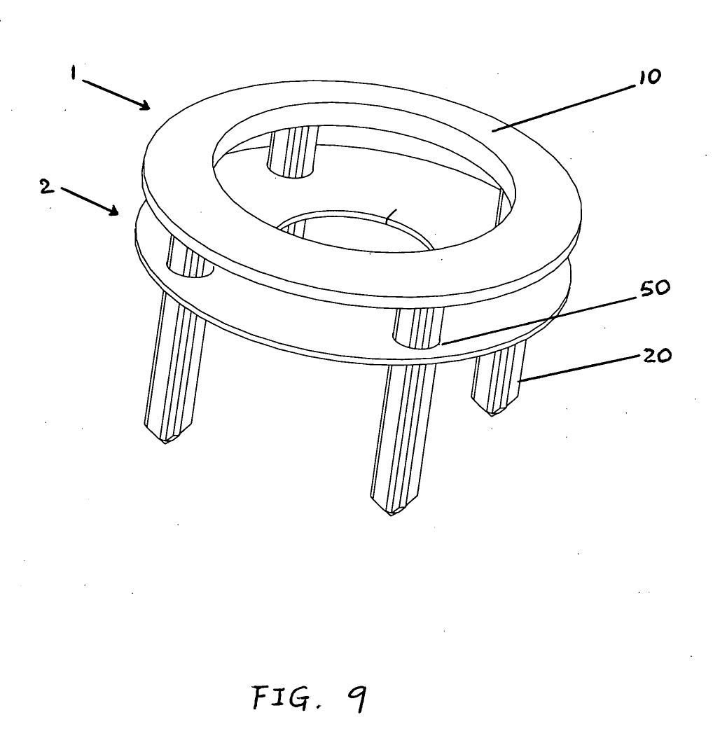

FIG. 8 is a bottom view of an alternate embodiment of the sprinkler cover 1. The sprinkler cover 1 has the shape of a three quarter of a circle with three stakes 20 instead of four as the shown in FIG. 7. This can be used to fit over sprinkler located along the edge of the lawn.

FIG. 9 is a perspective top view of a sprinkler spacer with an alternate embodiment of gasket 22 shown in FIG. 4.

In summary, it can be seen that what is provided in this invention is a sprinkler spacer to provide clearance between the sprinkler head and grass. To assemble the sprinkler spacer, have the sprinkler cover 1 sit upside down so stakes 20 pointing upward, then slip stake guided holes 50 of gasket 2 over stakes 20 of sprinkler cover 1. To install, the user has the sprinkler spacer centered over the sprinkler cap, then press down to the desired level. However, making sure that sprinkler spacer is not pushed below ground level as soil will cover it over time. It is most effective to have the sprinkler spacer surface level with or above the grass root. When this is done, the sprinkler spacer should cover soil and grass around the body of the sprinkler up to the outer perimeter of the device. The slope on the sprinkler cover surface 10 will ensure that most of the excess water during watering will drain outward away from the sprinkler body, and debris not accumulate on the surface over time. Gasket 2 will prevent grass from growing between the sprinkler body and sprinkler cover 1. With this device installed, the sprinkler can easily be located for routine inspection or service. The sprinkler spacer device does not interfere with lawn mowing operation.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. A sprinkler spacer for providing clearance between the in-ground sprinkler's head and grass. comprising:
means for water to be diverted outward away from the sprinkler to keep the soil around the sprinkler stay intact. the smooth surface of this element is for keeping dirt or debris from accumulating so grass is not able to grow on the surface.;
means for the sprinkler cover to be able to fit over the sprinkler cap.;
means for ease of cutting through the soil.;
means for allowing the gasket opening to go over a bigger object with ease.;
means for covering the soil between the sprinkler and the sprinkler cover so grass cannot grow over the covered area.; and
means for fitting the gasket over the sprinkler cover stakes.

2. The sprinkler spacer in accordance with claim 1, wherein said means for water to be diverted outward away from the sprinkler to keep the soil around the sprinkler stay intact. the smooth surface of this element is for keeping dirt or debris from accumulating so grass is not able to grow on the surface. comprises a smooth surface sprinkler cover surface, being slopped outward.

3. The sprinkler spacer in accordance with claim 1, wherein said means for the sprinkler cover to be able to fit over the sprinkler cap. comprises a circular opening sprinkler cover opening.

4. The sprinkler spacer in accordance with claim 1, wherein said means for ease of cutting through the soil. comprises a cross-shaped ground stake stakes.

5. The sprinkler spacer in accordance with claim 1, wherein said means for allowing the gasket opening to go over a bigger object with ease. comprises a stretchable gasket.

6. The sprinkler spacer in accordance with claim 1, wherein said means for covering the soil between the sprinkler and the sprinkler cover so grass cannot grow over the covered area. comprises a circular opening gasket center opening.

7. The sprinkler spacer in accordance with claim 1, wherein said means for fitting the gasket over the sprinkler cover stakes. comprises a circular opening stake guided holes.

8. A sprinkler spacer for providing clearance between the in-ground sprinkler's head and grass. comprising:
a smooth surface sprinkler cover surface, being slopped outward, for water to be diverted outward away from the sprinkler to keep the soil around the sprinkler stay intact. the smooth surface of this element is for keeping dirt or debris from accumulating so grass is not able to grow on the surface.;
a circular opening sprinkler cover opening, for the sprinkler cover to be able to fit over the sprinkler cap.;
a cross-shaped ground stake stakes, for ease of cutting through the soil.;
a stretchable gasket, for allowing the gasket opening to go over a bigger object with ease.;
a circular opening gasket center opening, for covering the soil between the sprinkler and the sprinkler cover so grass cannot grow over the covered area.; and
a circular opening stake guided holes, for fitting the gasket over the sprinkler cover stakes.

9. A sprinkler spacer for providing clearance between the in-ground sprinkler's head and grass. comprising:
a smooth surface sprinkler cover surface, being slopped outward, for water to be diverted outward away from the sprinkler to keep the soil around the sprinkler stay intact. the smooth surface of this element is for keeping dirt or debris from accumulating so grass is not able to grow on the surface.;
a circular opening sprinkler cover opening, for the sprinkler cover to be able to fit over the sprinkler cap.;
a cross-shaped ground stake stakes, for ease of cutting through the soil.;
a stretchable gasket, for allowing the gasket opening to go over a bigger object with ease.;
a circular opening gasket center opening, for covering the soil between the sprinkler and the sprinkler cover so grass cannot grow over the covered area.; and
a circular opening stake guided holes, for fitting the gasket over the sprinkler cover stakes.
